(19) United States
(12) Patent Application Publication
(10) Pub. No.: US 2026/0296335 A1
(43) Pub. Date: Oct. 1, 2026

(54) RESIN MEMBER AND DOOR GARNISH

(71) Applicant: MORIROKU CO., LTD., Tokyo (JP)

(72) Inventor: Tomohiro Yoshino, Tokyo (JP)

(21) Appl. No.: 19/545,714

(22) Filed: Feb. 20, 2026

(30) Foreign Application Priority Data
Mar. 28, 2025 (JP) 2025-055510

(51) Int. Cl. B60R 13/04; B32B 27/08; B60J 5/04; B60R 13/06

(52) U.S. Cl. CPC B60R 13/043; B32B 27/08; B60J 5/0463; B60R 13/06; B32B 2250/02; B32B 2605/00

(57) ABSTRACT

A resin member includes an inner member provided along an outer surface of another member; an outer member covering the inner member; a first seal fixed to the inner member so as to face the other member; and a second seal fixed to the inner member so as to face the outer member. The inner member includes a plurality of first seal fixing portions which are intermittently formed and to which the first seal is fixed, and a plurality of second seal fixing portions which extend along the outer member at portions between the first seal fixing portions and to which the second seal is fixed.

### FIELD OF THE INVENTION

The present invention relates to a resin member and a door garnish using the resin member.

### BACKGROUND

In many vehicles, a resin member is provided on a lower outer peripheral surface of a vehicle body for purposes of ornament and protection. As a conventional technique relating to such a resin member, there is a technique disclosed in U.S. Patent No. 7044524.

FIG. 3 of U.S. Patent No. 7044524 discloses a resin member composed of an inner member provided along an outer surface of a vehicle body and an outer member covering the inner member from outside.

### SUMMARY

According to the resin member as disclosed in U.S. Patent No. 7044524, the upper end of the inner member is provided so as to face the vicinity of the upper end of the outer member. For example, when vibration is input to the inner member from the vehicle body side, the inner member comes into contact with the outer member, thereby

generating noise, which is a risk. The resin member is not limited to being provided on the vehicle body, and there is a risk that the inner member and the outer member come into contact with each other when an external force is applied, and therefore, there is room for improvement in this regard.

An object of the present disclosure is to provide a resin member capable of suppressing the generation of noise.

According to the present disclosure, there is provided a resin member includes an inner member provided along an outer surface of another member; an outer member covering the inner member; a first seal fixed to the inner member so as to face the other member; and a second seal fixed to the inner member so as to face the outer member. The inner member includes a plurality of first seal fixing portions which are intermittently formed and to which the first seal is fixed, and a plurality of second seal fixing portions which extend along the outer member at portions between the first seal fixing portions and to which the second seal is fixed.

According to the present disclosure, it is possible to provide the resin member capable of suppressing the generation of noise.

### BRIEF DESCRIPTION OF THE DRAWINGS

FIG. 1 is a cross-sectional view of a resin member attached to another member, as viewed from the rear;

FIG. 2 is an enlarged perspective view of a portion 2 in FIG. 1;

FIG. 3 is an enlarged view of a main part of an inner member illustrated in FIG. 1;

FIG. 4A is an enlarged view of a portion 4A in FIGS. 3, and 4B is a view taken along arrow 4B in FIG. 4A;

FIG. 5 is a view taken along arrow 5 in FIG. 4A;

FIG. 6 is a cross-sectional view taken along line 6-6 in FIG. 5; and

FIG. 7 is a cross-sectional view taken along line 7-7 in FIG. 5.

### DETAILED DESCRIPTION

An embodiment of the invention will be described below with reference to the accompanying drawings. In the description, the terms “left” and “right” refer to left and right with respect to an occupant of a vehicle, and the terms “front” and “rear” refer to front and rear with respect to a traveling direction of the vehicle. In addition, in the drawings, Ce denotes the center of the vehicle width, Up denotes top or upward, and Dn denotes bottom or downward. The mode illustrated in the accompanying drawings is one example of the invention, and the invention is not limited to the mode.

### Embodiment

An embodiment will be described with reference to the drawings.

### Regarding resin member 20

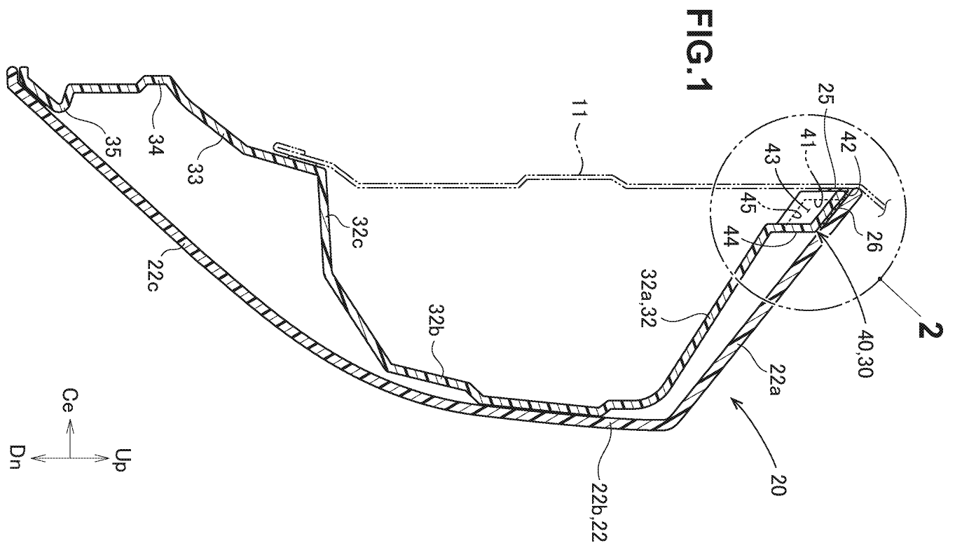

Referring to FIG. 1, FIG. 1 is a cross-sectional view illustrating a state in which a resin member 20 is attached to another member 11. Here, the other member 11 is a door for a vehicle constituting a part of a vehicle body, and the resin member 20 is a door garnish fixed to the vicinity of a lower end of the door for a vehicle. FIG. 1 illustrates a cross-section of the resin member 20 taken in a vehicle width direction, as viewed from the rear of a vehicle. Namely, the door for a vehicle is a door provided on the right side of the vehicle body.

The resin member 20 includes an inner member 30 fixed to the other member 11 via clips (not illustrated), and an outer member 22 fixed to the inner member 30 and covering the outer surface of the inner member 30.

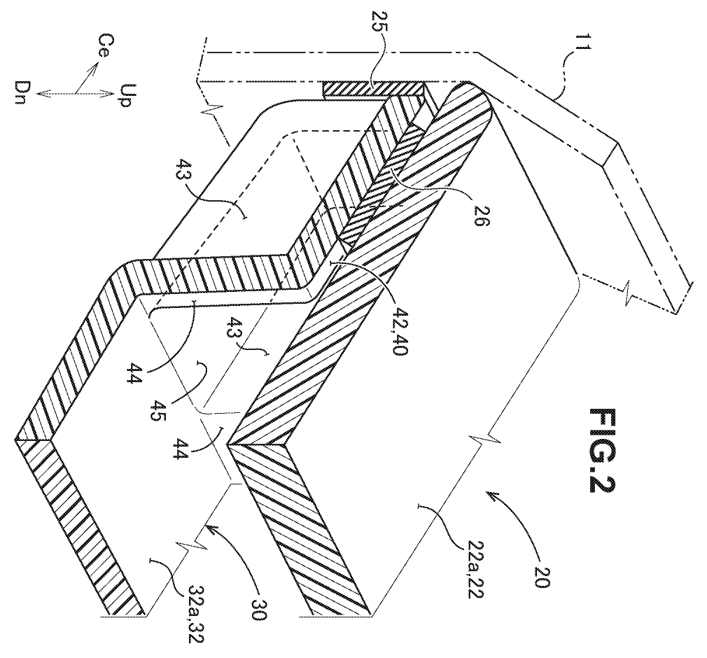

Referring to FIG. 2, the resin member 20 includes a first seal 25 fixed to the inner member 30 so as to face the other member 11, and a second seal 26 fixed to the inner member 30 so as to face the outer member 22.

### Regarding inner member 30

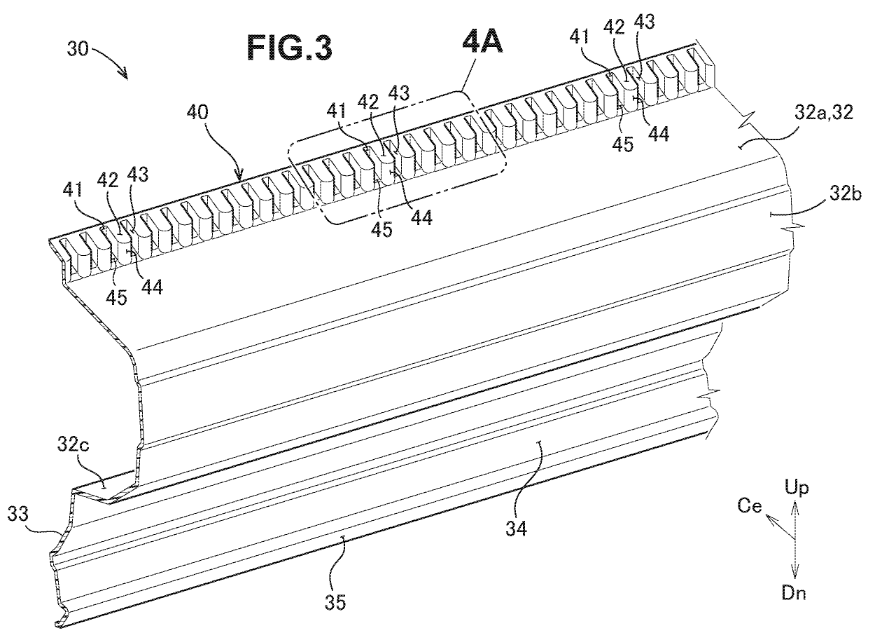

Referring to FIGS. 1 and 3, the inner member 30 is a resin component formed by integral molding. The inner member 30 includes a seal fixing portion 40 to which the first seal 25 (see FIG. 2) and the second seal 26 (see FIG. 2) are fixed; an inner body 32 having a substantially U shape that is integrally formed at a lower portion of the seal fixing portion 40 and that opens toward the center of the vehicle width; an inner inclined portion 33 formed to slope downward from the lower end of the inner body 32 toward the center of the vehicle width; an inner lower wall 34 extending downward from the lower end of the inner inclined portion 33; and an inner V-shaped cross-section portion 35 having a substantially V-shaped cross-section that is formed at the lower end of the inner lower wall 34 and that opens toward the center of the vehicle width.

The seal fixing portion 40 is preferably formed at the upper end of the inner member 30, but may be formed at other portions such as a lower portion.

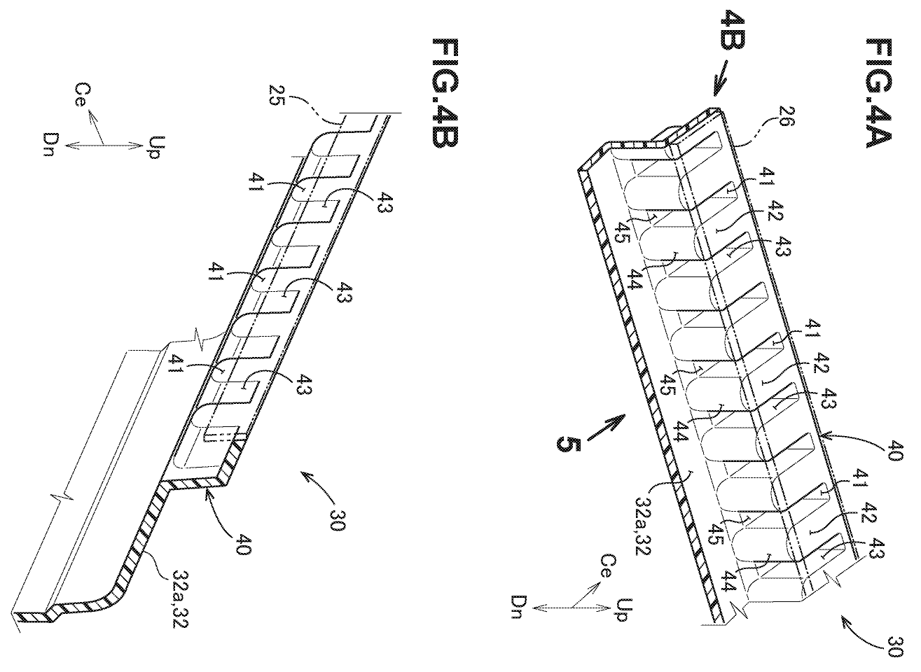

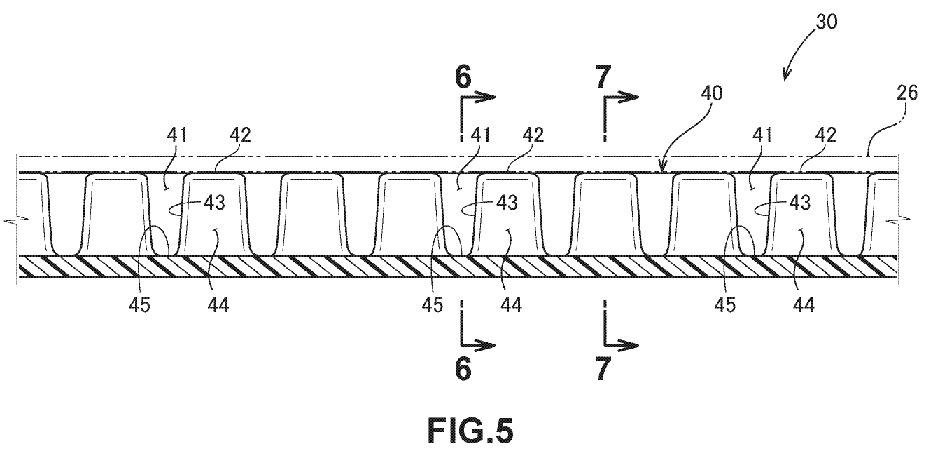

Referring to FIGS. 4A, 4B, and 5, the seal fixing portion 40 includes a first seal fixing portion 41 to which the first seal 25 is fixed, and a second seal fixing portion 42 to which the second seal 26 is fixed. The first seal fixing portions 41 and the second seal fixing portions 42 are alternately formed in large numbers along a front-rear direction. That is, both the first seal fixing portions 41 and the second seal fixing portions 42 are intermittently formed.

Referring to FIG. 4A, the seal fixing portion 40 further includes a plurality of spacing portions 43 extending along edges of the second seal fixing portions 42 so as to be spaced apart from the first seal fixing portions 41, and a plurality of connecting portions 44 extending along the edges of the second seal fixing portions 42 and connecting end portions of the spacing portions 43 to each other.

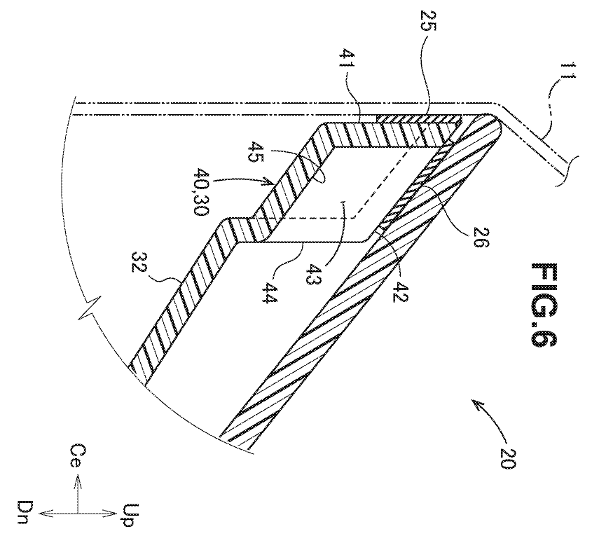

Referring to FIG. 6, the seal fixing portion 40 further includes a plurality of bottom portions 45 extending from lower ends of the first seal fixing portions 41 to the inner body 32.

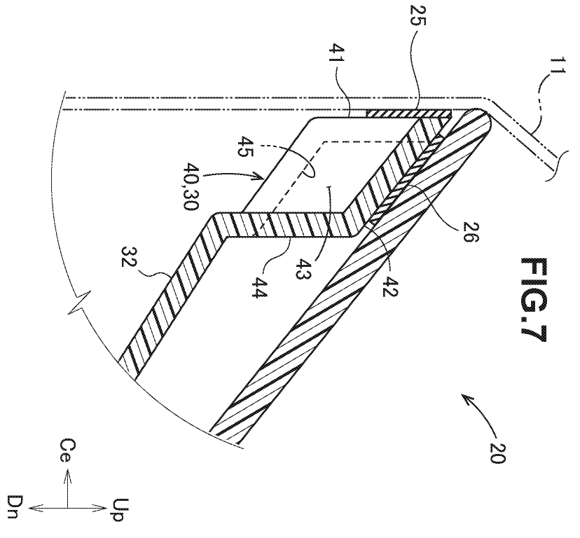

Referring to FIGS. 6 and 7, the seal fixing portion 40 can be re-stated as follows. The seal fixing portion 40 includes the bottom portions 45 extending intermittently from an end portion of the inner body 32 toward the other member 11; the first seal fixing portions 41 standing up from tips of the bottom portions 45 along the other member 11, the first seal 25 being fixed to the surfaces of the first seal fixing portions 41 facing the other member 11; the spacing portions 43 extending so as to be spaced apart from the first seal fixing portions 41 and standing up from edges of the bottom portions 45; the second seal fixing portions 42 which connect the adjacent spacing portions 43 to each other while avoiding positions where the spacing portions 43 face the bottom portions 45 and to which the second seal 26 is fixed; and the connecting portions 44 extending the other ends of the second seal fixing portions 42 toward the inner body 32 and connecting the spacing portions 43 to each other.

The first seal fixing portions 41 extend along the other member 11.

Referring to FIG. 4B, the surfaces of the first seal fixing portions 41 facing the other member 11 are formed on the same plane. Each of the first seal fixing portions 41 is formed such that the portion adjacent to the second seal fixing portions 42 has a rectangular shape and the tip has a semicircular shape. The shape of the first seal fixing portion 41 is not limited to such a shape, and may be a rectangular shape or any other shape as a whole.

Referring to FIG. 7, the second seal fixing portions 42 extend along the back surface of the outer member 22.

Referring to FIG. 4A, the surfaces of the second seal fixing portions 42 facing the outer member 22 are formed on the same plane. Each of the second seal fixing portions 42 is formed such that the portion adjacent to the first seal fixing portions 41 has a rectangular shape and the tip has a semicircular shape. The shape of the second seal fixing portion 42 is not limited to such a shape, and may be a rectangular shape or any other shape as a whole.

Each of the spacing portions 43 has a substantially rectangular shape (or parallelogram shape). The spacing portion 43 connects the first seal fixing portion 41 to the connecting portion 44, and connects the second seal fixing portion 42 to the bottom portion 45.

Each of the connecting portions 44 has a substantially U-shaped cross-section, and connects the second seal fixing portion 42 to the bottom portion 45. The connecting portion 44 also connects the adjacent spacing portions 43 to each other. The shape of the connecting portion 44 is not limited to such a shape, and may be a rectangular shape or any other shape as a whole.

Referring to FIG. 6, each of the bottom portions 45 connects the first seal fixing portions 41 to the inner body 32. A step is formed at the boundary portion between the bottom portion 45 and the inner body 32.

Referring to FIG. 1, the inner body 32 includes a body upper wall 32a that is continuous with the seal fixing portion 40 and is formed to slope downward toward the outer side in the vehicle width direction; a body vertical wall 32b extending from an end portion on the vehicle outer side of the body upper wall 32a and being partially in contact with the inner surface of the outer member 22; and a body lower wall 32c extending from the lower end of the body vertical wall 32b toward the center of the vehicle width.

The body vertical wall 2b partially protrudes toward the outer member 22, and the protruding portion is in contact with the back surface of the outer member 22. The protruding portion may be slightly spaced apart from the outer member 22.

An upper portion of the inner inclined portion 33 is in contact with the lower end of the other member 11.

The inner V-shaped cross-section portion 35 extends along a lower end portion of the outer member 22. The inner V-shaped cross-section portion 35 is formed in a V shape, so that the inner V-shaped cross-section portion 35 has higher strength than a flat plate-shaped portion and ensures a seal attachment surface.

### Regarding outer member 22

The outer member 22 is a resin member fixed to the inner member 30 via fastening means (not illustrated). The outer member 22 includes an outer upper portion 22a formed to slope downward toward the outer side of the vehicle along the upper surface of the inner member 30; an outer side portion 22b extending downward from the lower end of the outer upper portion 22a; and an outer lower portion 22c formed to slope downward from the lower end of the outer side portion 22b toward the center of the vehicle width.

In the outer member 22, unlike the inner member 30, no protruding portions (the second seal fixing portions 42) for bonding the second seal 26 are formed. In other words, the portions for fixing the seal are formed only in the inner member 30.

Factors that reduce appearance quality, such as sink marks, may occur in the vicinity of the protruding portions. High appearance quality can be ensured by not forming such portions in the outer member 22. Since the outer member 22 constitutes the design surface of the resin member 20, high appearance quality of the resin member 20 can be ensured.

The back surface of the tip of the outer upper portion 22a is placed on the upper surface of the second seal 26. The portions of the outer upper portion 22a other than the tip are spaced apart from the inner member 30.

The lower end of the outer lower portion 22c is bent along the shape of the inner V-shaped cross-section portion 35.

### Regarding first seal 25 and second seal 26

Referring to FIG. 2, both the first seal 25 and the second seal 26 are elongated plate-shaped components made of rubber or elastomer. The first seal 25 and the second seal 26 are bonded to the inner member 30 by an adhesive or double-sided tape.

Different materials can be used for the first seal 25 and the second seal 26, or the same material can be used. These materials can be selected as appropriate.

The resin member 20 described above is summarized as follows.

Referring to FIGS. 1 and 2, according to a first aspect, the resin member 20 includes the inner member 30 provided along the outer surface of the other member 11; the outer member 22 covering the inner member 30; the first seal 25 fixed to the inner member 30 so as to face the other member 11; and the second seal 26 fixed to the inner member 30 so as to face the outer member 22.

Referring to FIGS. 6 and 7, the inner member 30 includes the plurality of first seal fixing portions 41 which are intermittently formed and to which the first seal 25 is fixed, and the second seal fixing portions 42 which extend along the outer member 22 at portions between the first seal fixing portions 41 and to which the second seal 26 is fixed.

The plurality of first seal fixing portions 41 are intermittently formed to fix the first seal 25, and the plurality of the second seal fixing portions 42 are formed between the first seal fixing portions 41 to fix the second seal 26. Direct contact between the inner member 30 and the outer member 22 can be suppressed by providing the second seal 26 between the inner member 30 and the outer member 22. The second seal 26 sandwiched between the inner member 30 and the outer member 22 serves as a cushion, so that the generation of noise can be suppressed. That is, the resin member 20 capable of suppressing the generation of noise can be provided.

By employing a configuration in which the first seal fixing portions 41 and the second seal fixing portions 42 are alternately formed, the inner member 30 can be molded by integral molding without using a complex mold. Accordingly, the manufacturing cost of the inner member 30 can be reduced, and the resin member 20 as a whole can also be provided at a lower cost. In addition, since the configuration can be set in a space-saving manner, a seal attachment area at an end portion can be ensured.

Referring to FIG. 4A, according to a second aspect, in the resin member 20 according to the first aspect, the inner member 30 includes the spacing portions 43 extending along the edges of the second seal fixing portions 42 so as to be spaced apart from the first seal fixing portions 41. The loads applied to the first seal 25 and the second seal 26 can be received at the same portion. By receiving the loads at the same portion, the resin member 20 can be made more compact compared to a case in which the loads are received at different portions.

according to a third aspect, in the resin member 20 according to the second aspect, the inner member 30 includes the connecting portions 44 extending along the edges of the second seal fixing portions 42 and connecting the end portions of the spacing portions 43 to each other. The strength of the second seal fixing portions 42 can be further enhanced.

According to a fourth aspect, in the resin member 20 according to the second or third aspect, when the end portion of each of the spacing portions 43 that is connected to the first seal fixing portion 41 is defined as one end, the inner member 30 includes bottom portions 45, each extending from the first seal fixing portion 41 and connecting the other ends of the spacing portions 43 of the adjacent first seal fixing portions 41 to each other. The strength of the first seal fixing portions 41 can be enhanced. In addition, the strength of the second seal fixing portions 42 can be enhanced via the spacing portions 43.

Referring to FIG. 1, according to a fifth aspect, in the resin member 20 according to any one of the first to fourth aspects, the resin member 20 is a door garnish attached to a door for a vehicle as the other member 11. The commercial value of the vehicle can be enhanced by using the resin member 20 having high quietness.

The other member 11 to which the resin member 20 is attached may be a left door for a vehicle or may be any other portion of the vehicle body. Furthermore, the other member 11 may be a member other than the vehicle body. That is, the invention is not limited to the embodiment as long as the functions and effects of the invention are achieved.

What is claimed is:

1. A resin member comprising:
an inner member provided along an outer surface of another member;
an outer member covering the inner member;
a first seal fixed to the inner member so as to face the other member; and
a second seal fixed to the inner member so as to face the outer member,
wherein the inner member comprises a plurality of first seal fixing portions which are intermittently formed and to which the first seal is fixed, and a plurality of second seal fixing portions which extend along the outer member at portions between the first seal fixing portions and to which the second seal is fixed.

2. The resin member according to claim 1,
wherein the inner member comprises a plurality of spacing portions extending along edges of the second seal fixing portions so as to be spaced apart from the first seal fixing portions.

3. The resin member according to claim 2,
wherein the inner member comprises a plurality of connecting portions extending along the edges of the second seal fixing portions and connecting end portions of the spacing portions to each other.

4. The resin member according to claim 2,
wherein when an end portion of each of the spacing portions that is connected to the first seal fixing portion is defined as one end, the inner member comprises a plurality of bottom portions, each extending from the first seal fixing portion and connecting the other ends of the spacing portions of the adjacent first seal fixing portions to each other.

5. The resin member according to claim 2,
wherein the resin member is a door garnish attached to a door for a vehicle as the other member.
